(19) United States
(12) Patent Application Publication
(10) Pub. No.: US 2025/0167639 A1
(43) Pub. Date: May 22, 2025

(54) INVERTER WITH A TEMPERATURE MEASURING SYSTEM

(71) Applicant: ZF Friedrichshafen AG, Friedrichshafen (DE)

(72) Inventors: Johannes Maier, Bamberg (DE); Michael Arnegger, Grünkraut (DE)

(73) Assignee: ZF Friedrichshafen AG, Friedrichshafen (DE)

(21) Appl. No.: 18/956,389

(22) Filed: Nov. 22, 2024

(30) Foreign Application Priority Data
Nov. 22, 2023 (DE) 10 2023 211 614.6

(51) Int. Cl. H02K 11/33; H02K 11/25

(52) U.S. Cl. CPC H02K 11/33; H02K 11/25

(57) ABSTRACT

An inverter contains at least one phase, and includes a base plate, at least one half bridge on the base plate, which has a high side for at least one semiconductor package forming a high side switch, and a low side for at least one parallel semiconductor package forming a low side switch, wherein each semiconductor package is encased in a non-conductive coating. The inverter also includes a temperature measuring system for measuring the temperature of the semiconductor packages in the inverter, and the temperature measuring system includes at least one substrate placed on or above the coating on at least one of the semiconductor packages, and at least one temperature measuring element on or in the substrate, which is designed to at least detect the surface temperature of the coating on at least one semiconductor package.

### CROSS-REFERENCE TO RELATED APPLICATION

This application claims priority to German Patent Application No. 10 2023 211 614.6, filed on Nov. 22, 2023, the entirety of which is hereby fully incorporated by reference herein.

### TECHNICAL FIELD

The present disclosure relates to the field of electric mobility, in particular monitoring power semiconductors in a semiconductor package contained in an inverter for a power semiconductor module for powering an electric drive.

### BACKGROUND

Electronic modules, i.e. power electronics modules, have been used to an increasing extent in motor vehicles over the previous decades. This is because of the necessity of conserving fuel and improving vehicle performance, as well as because of the advances in semiconductor technology. The main components in such a power electronics module are an electronic control unit (ECU), which is connected to or part of the vehicle control units and receives control signals and/or information based on driving behavior or signals from other control units, and a DC/AC inverter, with which electric machines such as motors or generators are provided with a multiphase alternating current (AC). This involves converting direct current generated by a DC power source such as a battery into a multiphase alternating current. The inverters contain numerous electronic components for this that form bridge circuits (half bridges), e.g. semiconductor switches, also referred to as power semiconductors.

The power semiconductors are temperature sensitive and must therefore be cooled by a cooling system. This requires monitoring the temperature of at least some of the power semiconductors in order to take appropriate measures in the event of overheating, to avoid damaging the inverters. There are numerous ways of monitoring the temperature of power semiconductors. The monitoring can be integrated directly in the power semiconductor modules, e.g. in the form of a temperature sensor or sensor diodes. The temperature of the semiconductor package can also be measured directly, e.g. on the housing (coating) or power semiconductor. This measurement can be made with or without contact to the housing.

The challenges involved in measuring temperatures in inverters relate to the insulation between the high and low voltages, depending on where the temperature sensor is located. Signal transfer, i.e. the time between taking a measurement and processing the measurement, as well as the response time of the temperature sensors and the available installation space, in particular the space on the printed circuit board for signal processing, must be taken into account. Thermal contact during vibration and thermal expansion must also be considered when measuring temperatures.

### SUMMARY

Because there is still room for improvement in measuring temperatures of power semiconductors in an inverter, an object of the present disclosure is to create a better temperature measuring system for measuring the temperatures of power semiconductors in an inverter.

This problem is solved by the features of the present disclosure. Advantageous embodiments are also the subject matter of the present disclosure. Further features and advantages can be derived from the following descriptions of exemplary embodiments based on the drawings, which show details of the present disclosure. The individual features can be implemented in and of themselves or in numerous arbitrary combinations, forming variations of the present disclosure.

An inverter with a temperature measuring system is obtained with which the temperatures of semiconductor packages in an inverter can be measured, in which the inverter contains at least one phase, and comprises a base plate, at least one half bridge on the base plate that has a high side, which contains at least one semiconductor package forming a high side switch, and a low side, which contains at least one semiconductor package forming a low side switch, which is opposite and connected in parallel to the high side switch, in which each semiconductor package is encased in an electrically insulating coating. The temperature measuring system contains at least one substrate applied to the semiconductor package on or above the coating, and at least one temperature measuring element on or in this substrate, which is configured to at least detect the surface temperature of the coating on at least one semiconductor package.

In one embodiment, the temperature measuring element is a temperature sensor or resistor strip.

In one embodiment, there is a temperature measuring element for each semiconductor package, or for each phase or for each high side and/or each low side, or for all of the phases.

In one embodiment, the substrate is U-shaped, extending over one or all of the phases. In one embodiment, the substrate is formed by two strips, each of which extends uninterrupted over one or all of the phases of the high side or low side. In one embodiment, the substrate covers the top of the semiconductor package.

In one embodiment, the substrate is attached to the semiconductor package. In one embodiment, the substrate is integrated in a coating of a busbar directly above the semiconductor package.

In one embodiment, the substrate is formed by a film, a flexible film, a PCB, or copper strips.

In one embodiment, each substrate has at least one contact point at which the temperature measuring system is connected to an external processor.

An electronic module is also created that contains the inverter described above.

An electric motor is also created, in particular an electric axle drive, for a vehicle that has at least one electric drive and the electronics module described above for controlling the electric motor.

A vehicle is also created that contains the electric motor described above.

Preferred embodiments shall be explained in greater detail below in reference to the drawings.

### BRIEF DESCRIPTION OF THE DRAWINGS

FIGS. 1, 2, and 3 each show an inverter with a temperature measuring system in accordance with different embodiments of the present disclosure.

FIGS. 4, 5, and 6 each show an inverter with a temperature measuring system according to different alternative embodiments of the present disclosure.

FIG. 7 shows an inverter that has a temperature measuring system according to another alternative embodiment of the present disclosure.

### DETAILED DESCRIPTION

Identical elements and functions have the same reference symbols in the following description of the drawings.

Current inverters used in the field of electric mobility often have three phases. A so-called three-phase module can be used for this, in which there is a single base plate 2 for all three phases P1-P3, populated by semiconductor packages 4 encased in a casting compound, as shown in the drawings. There are contacts outside the coatings of the semiconductor packages 4 for a dedicated busbar. The semiconductor packages 4 are attached directly to the base plate 2, e.g. by sintering.

The base plate 2 forms a substrate, and is made of a sufficiently robust material with good thermal conductivity such as copper, such that the semiconductor packages can be sufficiently cooled and secured in place. It is therefore not a printed circuit board, and has no current or signal conductors. It can be made of an electrically conductive material, and thus form a ground (GND). It can also be made of a non-conductive material, in which case the ground (GND) can be formed by a screw.

The semiconductor packages 4 are normally placed opposite one another, such that pairs thereof form half bridges with a central AC pickup 7, one of which forms a high side switch, and the other forms a low side switch. There are power semiconductors, e.g. MOSFETs, IGBTs, etc. in each semiconductor package 4, which are connected in parallel to one another.

There can be one or more half bridges for each phase P1-P3. By way of example, three half bridges are shown for each phase P1-P3 in the drawings.

DC and AC busbars are placed above the semiconductor packages 4, which are in electrical contact with terminals in the half bridges.

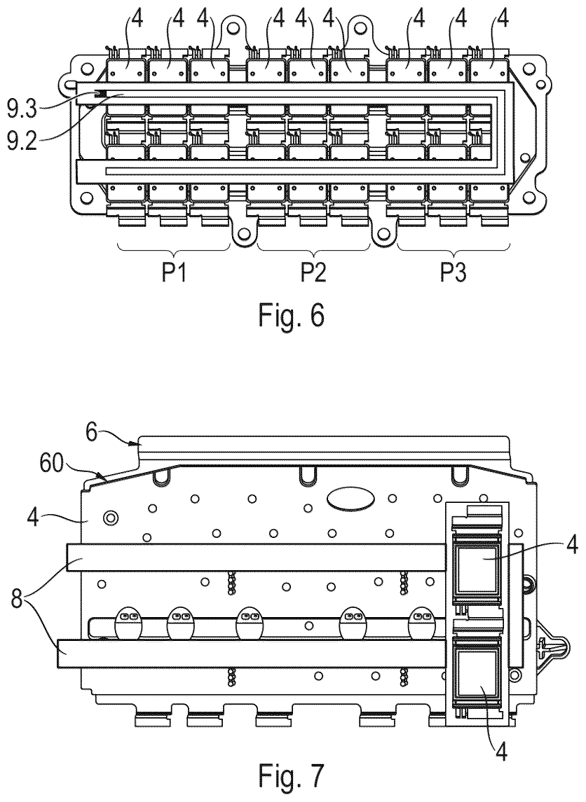

There is also a DC busbar, preferably a negative DC busbar 6, on top of the semiconductor packages 4, as shown in FIG. 7. The other busbars (DC-positive and AC) are not shown, but are stacked above or below the negative DC busbar 6, and electrically connected to the dedicated terminals in the semiconductor packages 4, in which the AC pickup 7 is placed between two opposing semiconductor packages 4, as shown in the drawings.

In existing embodiments, the negative DC busbar 6 has holes through which high voltage current and/or signal pins for the semiconductor packages 4 and/or current pins for the positive DC busbar can extend above the negative DC busbar 6, and the AC terminals for the AC busbar above the negative DC busbar 6 can pass through to the AC pickups 7 in the semiconductor packages 4 below the negative DC busbar 6. There are usually one or more holes in the negative DC busbar 6 for this, in order to place one or more temperature sensors on the bottom of the negative DC busbar 6 with which the temperatures of the semiconductor packages 4 are measured.

The challenge with measuring temperatures in inverters involves insulating high voltages and low voltages, depending on where the temperature sensor is located. Signal transfer, i.e. the time between taking the measurement and processing the measurement, as well as the response time of the temperature sensors and the available installation space, in particular the space on the printed circuit board above the busbars for signal processing, must be taken into account. Thermal contact, vibrations, and thermal expansion also play a role in measuring temperatures.

For these reasons, a temperature measuring system for an inverter is proposed in which the surface temperature of the plastic coating on power semiconductors is monitored. This means that the temperature is measured directly on the coating 60 for the semiconductor packages 4. The results (raw or processed data) are then transferred to a processor through a contact point 9.3. If overheating is detected in at least one semiconductor package 4, measures established in the prior art are taken.

Different embodiments of the temperature measuring system are described below in reference to the drawings. The temperature measuring element is placed on a substrate layer 8 in all of these embodiments. The substrate 8 can be a film applied to the semiconductor package, or a flexible printed circuit board or copper strips.

In a first embodiment, the temperature measuring elements in the system are temperature sensors 9.1 attached to a substrate 8 with an adhesive, for example. The temperature sensors 9.1 can be negative temperature coefficient (NTC) thermistors, Pt100 or Pt1000 elements, or optical sensors, in the last of which the processing of the measurement data takes places in an external processor that is connected to the temperature sensors 9.1 by the contact point 9.3. The substrate 8 can be attached to the top of the semiconductor package 4, i.e. the housing, with an adhesive.

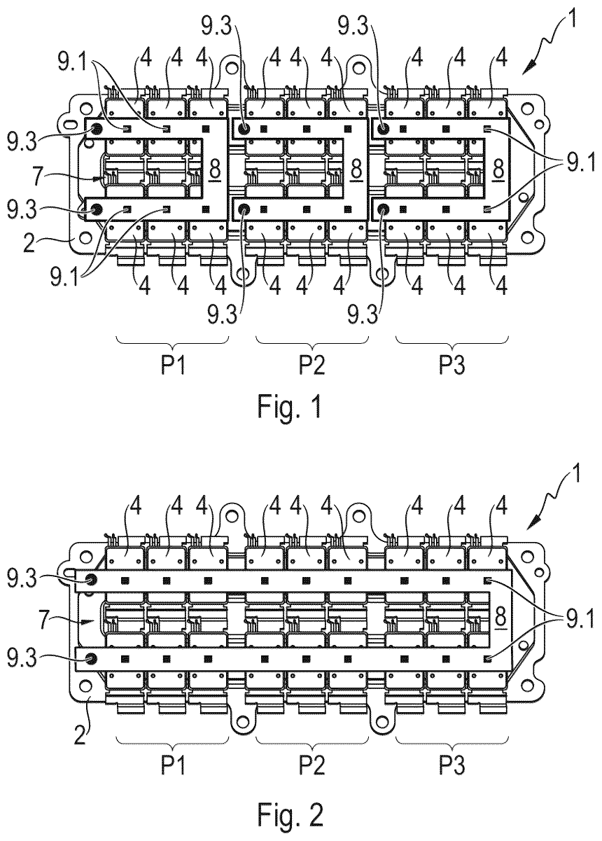

FIG. 1 shows a design for the first embodiment in which there is a separate temperature measuring system for each phase P1-P3. The substrate 8 is U-shaped, and one leg thereof extends over one row of semiconductor packages, and the other extends over a parallel row of semiconductor packages 4. The connecting portion (at the right in each case in FIG. 1) joins the two legs through the AC pickup 7. There is a contact point 9.3 on each of the ends (at the left in each case in FIG. 2), through which the measurement data can be exported, e.g. to an external processor. There is also a separate temperature sensor 9.1 for each semiconductor package 4 in this embodiment, which is placed substantially in the middle of the housing. If it is known where an increase in temperature is most critical in the semiconductor package 4, the sensor 9.1 can be placed above this area, and the size and shape of the substrate 8 can also be adjusted for this.

FIG. 2 shows a design for the first embodiment in which there is just one temperature measuring system for all of the phases P1-P3. The difference to that shown in FIG. 1 is that the substrate 8 extends over all of the semiconductor packages 4 in all of the phases P1-P3, in that both legs of the “U” are longer. There is still a contact point 9.3 at each end, and there is a separate temperature sensor 9.1 for each semiconductor package 4, as is the case with the embodiment shown in FIG. 1.

FIG. 3 shows a design for the first embodiment in which there are two temperature measuring systems. The substrate 8 in this case is formed by two parallel strips that extend over all of the phases P1-P3, one of which is on the semiconductor packages 4 forming the high side, and the other is on those forming the low side. There is still a contact point 9.3 on each of the ends, and a separate sensor 9.1 for each semiconductor package 4, as is the case with the embodiment shown in FIG. 1.

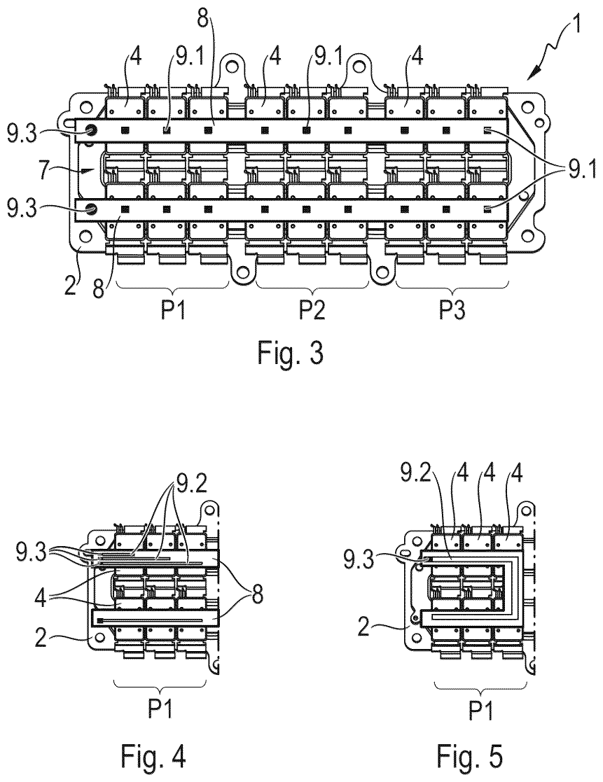

In another embodiment, the temperature measuring elements in the system are resistor strips 9.2, as shown in FIGS. 4 to 6. These can be attached to the substrate with an adhesive, or they can be embedded in the substrate 8, e.g. forming conductor paths in a printed circuit board (PCB). The measurement takes place with four-terminal sensing, thus eliminating the need for temperature sensors. The resistor strips 9.2 are made of a thermally conductive material, ideally copper, in which case the measurement is based on its behavior at different temperatures. In this case, the substrate 8 cannot be made of copper.

FIG. 4 shows a section containing just one phase P1, schematically illustrating two different designs for the second embodiment. On the upper semiconductor packages 4 in FIG. 4 there is one resistor strip 9.2 with a contact point 9.3 for each semiconductor package 4. This allows for the temperature of each semiconductor package 4 to be measured individually. The resistor strips 9.2 can be insulated where they extend over semiconductor packages 4 that are not to be monitored. The insulation can also be part of the substrate 8. A resistor strip 9.2 extends over all of the lower semiconductor packages 4 in FIG. 4, with just one contact point 9.3. In this case, the temperature of all of the semiconductor packages 4 underneath the resistor strip 9.2 is measured collectively.

FIG. 5 shows a design for the second embodiment in which a single resistor strip 9.2 extends over all of the semiconductor packages 4 in a phase P1. The substrate 8 is U-shaped, like that in FIG. 1, such that one leg extends over one row of semiconductor packages 4 and the other extends over a parallel row. The connecting portion joins the two legs through the AC pickup 7.

FIG. 6 shows a design for the second embodiment in which a single resistor strip 9.2 extends over all of the semiconductor packages 4 in all of the phases P1-P3. The substrate 8 is U-shaped, like that in FIG. 1, with longer legs on the “U.”

The embodiments shown in FIGS. 5 and 6 could also contain numerous resistor strips 9.2, in order to monitor the temperatures of each semiconductor package 4, as is the case in the upper row in FIG. 4.

Because the negative DC busbar 6 is placed on top of the semiconductor packages 4, undesired electrical interactions with components above or below them, in particular the positive DC and AC busbars, may occur. For this reason, the negative DC busbar 6 is completely coated 60 where it covers the other busbars, i.e. where it is not to come in contact therewith, to insulate it against the environment, in particular against the positive DC and AC busbars. The coating 60 is placed above the semiconductor packages 4 in particular, but not at the electrical contact points. The coating 60 is made of an electrically insulating material, preferably a casting compound, which can be applied thereto, as is the case in the prior art, and therefore needs no further explanation.

This coating 60, like that on the negative DC busbar placed above the semiconductor packages 4 described above, also has numerous holes for various components extending from its lower surface facing the base plate 2 to its upper surface (or vice versa). The openings are aligned with those in the negative DC busbar 6.

In one embodiment, the temperature measuring system is integrated in the coating 60 on the negative DC busbar, i.e. embedded therein, as is schematically indicated in FIG. 7. This takes place while the coating 60 is being formed. The temperature measuring system can be any of those described above, i.e. as individual sensors 9.1 on a substrate 8, (FIGS. 1 to 3), or as resistor strips 9.2 on a substrate 8 (FIGS. 4 to 6). The contact points 9.3 also remain intact. The temperature of the coating 60 for the semiconductor packages 4 can also be monitored if the temperature measuring elements 9.1, 9.2 are not in direct contact with the coating 60 on the semiconductor packages 4, but at small distance thereto, as is the case with the negative DC busbar 6.

The surface temperature of the semiconductor packages 4 can be monitored with the proposed temperature measuring system, in which the placement of the temperature measuring elements 9.1, 9.2 can be readily varied.

The proposed temperature measuring system can also be used in a multiphase module with more than three phases, or in a single-phase module, in which it is intended for each phase (and thus each module) in the inverter, as is the case with the embodiments shown in FIGS. 1 to 5.

The substrate 8 can also cover all of the semiconductor packages 4 in all of the embodiments, as long are there are holes for AC contacts, for example.

The present disclosure has been described for a negative DC busbar 6 that extends entirely over the semiconductor packages 4. This is a preferred embodiment. It is also possible to integrate the temperature measuring system in one of the other busbars (DC or AC), as long as it is close enough to the semiconductor packages 4.

A major advantage of the proposed temperature measuring system is that it has a modular construction with regard to the number of temperature measuring elements. By way of example, there can be one or more temperature measuring elements for each phase P1-P3 or one temperature measuring element for each semiconductor package 4, or one temperature measuring element for each high side or each low side of the semiconductor packages 4.

The proposed inverter 1 (DC/AC inverter) is part of an electronics module and preferably has three phases P1-P3. The electronics module is used to power a three-phase electric motor in a vehicle, and is connected to an electronic control unit (ECU) functioning as a driver, for signal exchange. The ECU controls and regulates the inverter and the electric motor.

The electronics module is connected to the electric motor and a battery in the vehicle such that direct current from the battery is converted by the inverter into alternating current for powering the electric motor. The electric motor forms an electric axle drive in particular. The vehicle, a passenger automobile or utility vehicle, advantageously contains at least one such drive.

### LIST OF REFERENCE SYMBOLS

P1-P3 phase 1, phase 2, phase 3
1 three-phase module
2 base plate
4 semiconductor package
6 negative DC busbar
60 coating for 6
7 AC pickup
8 substrate
9.1 temperature sensor
9.2 resistor strip
9.3 contact point

1. An inverter comprising:
a base plate;
at least one half bridge on the base plate, which has a high side for at least one semiconductor package forming a high side switch, and a low side for at least one parallel semiconductor package forming a low side switch, wherein each semiconductor package is encased in a non-conductive coating; and
a temperature measuring system configured to measure a temperature of the semiconductor packages in the inverter, wherein the inverter includes at least one phase, wherein the temperature measuring system comprises:
at least one substrate placed on or above a coating on at least one of the semiconductor packages; and
at least one temperature measuring element on or in the at least one substrate, which is configured to at least detect a surface temperature of the coating on at least one semiconductor package.

2. The inverter according to claim 1, wherein the temperature measuring element comprises a temperature sensor or resistor strip.

3. The inverter according to claim 1,
wherein the temperature measuring system comprises:
a temperature measuring element for each semiconductor package, or for each phase, or for each high side and/or low side, or for all of the phases.

4. The inverter according to claim 1,
wherein the at least one substrate extends in a U-shape over one or all of the at least one phase.

5. The inverter according to claim 1,
wherein the at least one substrate is formed by two strips, each of which extends continuously over one or all of the at least one phase, over the high side or low side.

6. The inverter according to claim 1,
wherein the at least one substrate extends over the semiconductor packages.

7. The inverter according to claim 1,
wherein the at least one substrate is attached to the semiconductor packages.

8. The inverter according to claim 1,
wherein the at least one substrate is integrated in a coating on a busbar directly above the semiconductor packages.

9. The inverter according to claim 1,
wherein the at least one substrate is a film, a flexible film, a PCB, or a copper strip.

10. The inverter according to claim 1,
wherein each of the at least one substrate contains at least one contact point with which the temperature measuring system is connected to an external processor.

11. An electronics module comprising:
the inverter according to claim 1.

12. An electric motor for a vehicle comprising:
at least one electric drive; and
the electronics module according to claim 11 configured to control the electric motor.

13. A vehicle comprising:
the electric motor according to claim 12.
